(19) United States
(12) Patent Application Publication
(10) Pub. No.: US 2016/0269466 A1
(43) Pub. Date: Sep. 15, 2016

(54) METHOD AND DEVICE FOR FILTERING INFORMATION

(71) Applicant: Xiaomi Inc., Beijing (CN)

(72) Inventors: Jinsong Fan, Beijing (CN); Yi Zhong, Beijing (CN); Zhongyi Du, Beijing (CN)

(21) Appl. No.: 14/968,927

(22) Filed: Dec. 15, 2015

(30) Foreign Application Priority Data
Mar. 11, 2015 (CN) 201510105528.X

(51) Int. Cl. H04L 29/08; H04L 29/06

(52) U.S. Cl. CPC H04L 67/02; H04L 67/42

(57) ABSTRACT

The present disclosure provides a method and a device for filtering information. The method includes: acquiring a network identity of a network currently accessed, wherein the network identity is an identity of a communication carrier providing the network; detecting whether an information filtering rule corresponding to the network identity is stored; and if the information filtering rule is stored, filtering carrier-inserted code in webpage code according to the information filtering rule, wherein the webpage code is sent from a web server to a client terminal via a carrier server.

### CROSS-REFERENCE TO RELATED APPLICATIONS

This application is based upon and claims priority to Chinese Patent Application No. 201510105528.X, filed Mar. 11, 2015, the entire contents of which are incorporated herein by reference.

### TECHNICAL FIELD

The present disclosure relates to the field of Internet technologies, and more particularly, to a method and a device for filtering information.

### BACKGROUND

When browsing a webpage by using a browser, the user may send a HTTP (HyperText Transfer Protocol) request to a server of a communication carrier (carrier server) via a network provided by the communication carrier, and then the carrier server forwards the HTTP request to a corresponding web server.

After receiving the HTTP request, the web server returns corresponding HTML (HyperText Markup language) code to the client terminal browsing the webpage via the carrier server, then the browser parses and displays the HTML code so as to achieve display of the webpage.

### SUMMARY

A method for filtering information in accordance with some embodiments, includes: acquiring a network identity of a network currently accessed, wherein the network identity is an identity of a communication carrier providing the network; detecting whether an information filtering rule corresponding to the network identity is stored; and if the information filtering rule is stored, filtering carrier-inserted code in webpage code according to the information filtering rule, wherein the webpage code is sent from a web server to a client terminal via a carrier server.

A device for filtering information in accordance with some embodiments, includes: a processor; and a memory for storing instructions executable by the processor; wherein the processor is configured to: acquire a network identity of a network currently accessed, wherein the network identity is an identity of a communication carrier providing the network; detect whether an information filtering rule corresponding to the network identity is stored; and if the information filtering rule is stored, filter carrier-inserted code in webpage code according to the information filtering rule, wherein the webpage code is sent from a web server to a client terminal via a carrier server.

In accordance with some embodiments, a non-transitory readable storage medium including instructions is provided. The instructions is executable by a processor in a device, for performing a method for filtering information. The method includes: acquiring a network identity of a network currently accessed, wherein the network identity is an identity of a communication carrier providing the network; detecting whether an information filtering rule corresponding to the network identity is stored; and if the information filtering rule is stored, filtering carrier-inserted code in webpage code according to the information filtering rule, wherein the webpage code is sent from a web server to a client terminal via a carrier server.

The embodiments of the present disclosure may, in part, include the following advantageous effects: the code inserted by the carrier in the webpage code is filtered by using the information filtering rule corresponding to the current network. Thus, the normal browsing of the user is not affected by displaying of the advertisement inserted by the carrier on the webpage, and the advertisement inserted in the webpage by the carrier and ensuring the display of contents of the webpage is filtered.

It is to be understood that both the foregoing general description and the following detailed description are exemplary and explanatory only.

### BRIEF DESCRIPTION OF THE DRAWINGS

The accompanying drawings, which are incorporated in and constitute a part of this specification, together with the description, serve to explain the embodiments.

FIG. 1 is an environmental view of an implementation environment involved by respective embodiments in the present disclosure;

FIG. 2 is a flow chart showing a method for filtering information, according to one exemplary embodiment;

FIG. 3A is a flow chart showing a method for filtering information, according to another exemplary embodiment;

FIG. 3B is a flow chart of detecting an action of inserting code by a carrier in the method for filtering information, according to another exemplary embodiment;

FIG. 3C is a flow chart of generating an information filtering rule in the method for filtering information, according to another exemplary embodiment;

FIG. 4 illustrates a block diagram of an apparatus for filtering information, according to an exemplary embodiment;

FIG. 5 illustrates a block diagram of an apparatus for filtering information, according to another exemplary embodiment; and

FIG. 6 illustrates a block diagram of a device for filtering information, according to an exemplary embodiment.

Specific embodiments in this disclosure have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

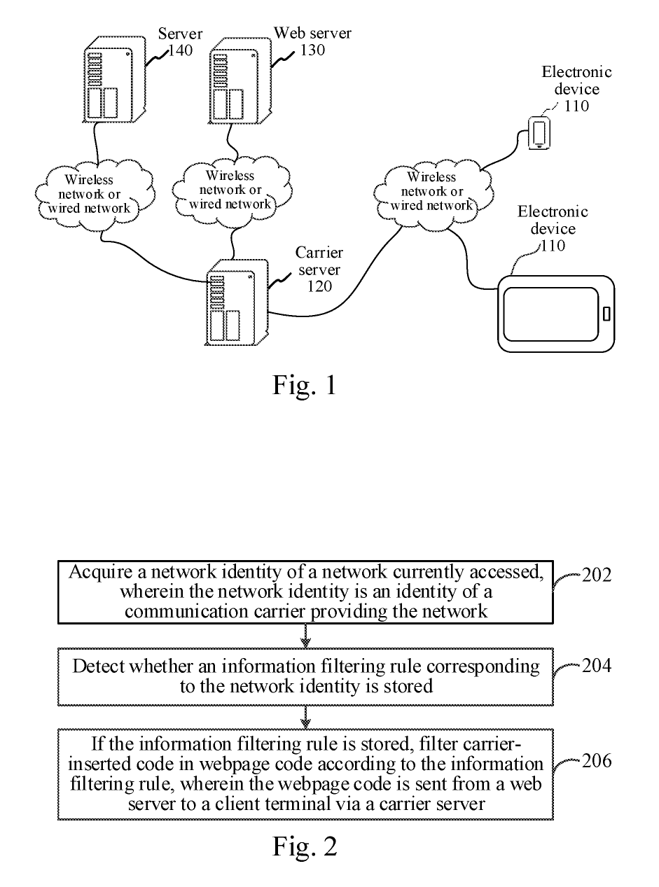

FIG. 1 is an environmental view of an implementation environment involved by respective embodiments in the present disclosure. The implementation environment includes an electronic device 110, a carrier server 120, a web server 130 and a server 140.

The electronic device 110 may be implemented by an electronic device installed with a browser client terminal. The electronic device may be a smartphone, a tablet, an e-book reader, a portable laptop computer (camera, video camera), and the like.

The electronic device 110 is connected with the carrier server 120 via a wired or wireless network.

The carrier server 120 may be one server, or a server cluster consisting of several servers, or a cloud computing service center. The carrier server 120 is used for forwarding a HTTP request sent by the electronic device 110 to the web server 130, and sending data returned by the web server 130 to the electronic device 110.

The carrier server 120 is connected with the web server 130 via a wired or wireless network.

The web server 130 may be one server, or a server cluster consisting of several servers, or a cloud computing service center. The web server 130 is used for returning corresponding data according to the received HTTP request.

The server 140 is connected with the carrier server 120 via a wired or wireless network.

The server 140 may be one server, or a server cluster consisting of several servers, or a cloud computing service center. The server 140 is used for aggregating information filtering rules sent by respective electronic devices 110, and generating update information for the information filtering rules of respective communication carriers.

In order to simplify the description, hereinafter, an information filtering method performed by the client terminal is exemplified, but the present disclosure is not limited thereto.

FIG. 2 illustrates a flow chart of a method for filtering information, according to one exemplary embodiment. In the present embodiment, the method for filtering information used in the electronic device 110 shown in FIG. 1 is explained. The method for filtering information may include the following steps.

In step 202, a network identity of a network currently accessed is acquired, and the network identity is an identity of a communication carrier providing the network.

In step 204, whether an information filtering rule corresponding to the network identity is stored is detected.

In step 206, if the information filtering rule is stored, code inserted by the carrier (carrier-inserted code) in webpage code is filtered according to the information filtering rule, wherein the webpage code is sent from a web server to a client terminal via a carrier server.

Thus, in the method for filtering information provided by the present exemplary embodiment, the code inserted by the carrier in the webpage code is filtered by using the information filtering rule corresponding to the current network. Thus, the normal browsing of the user is not affected by displaying of the advertisement inserted by the carrier on the webpage, and the advertisement inserted in the webpage by the carrier and ensuring the display of contents of the webpage is filtered.

In accordance with some embodiments, the client terminal detects whether a corresponding information filtering rule is stored according to the acquired network identity, and filters the advertisement inserted by the carrier according to the information filtering rule; when no corresponding information filtering rule is stored, the client terminal detects whether an advertisement is inserted by the carrier, and when the carrier inserts an advertisement, the client terminal generates a corresponding information filtering rule and filters the advertisement. Hereinafter, one embodiment is adopted for explanation.

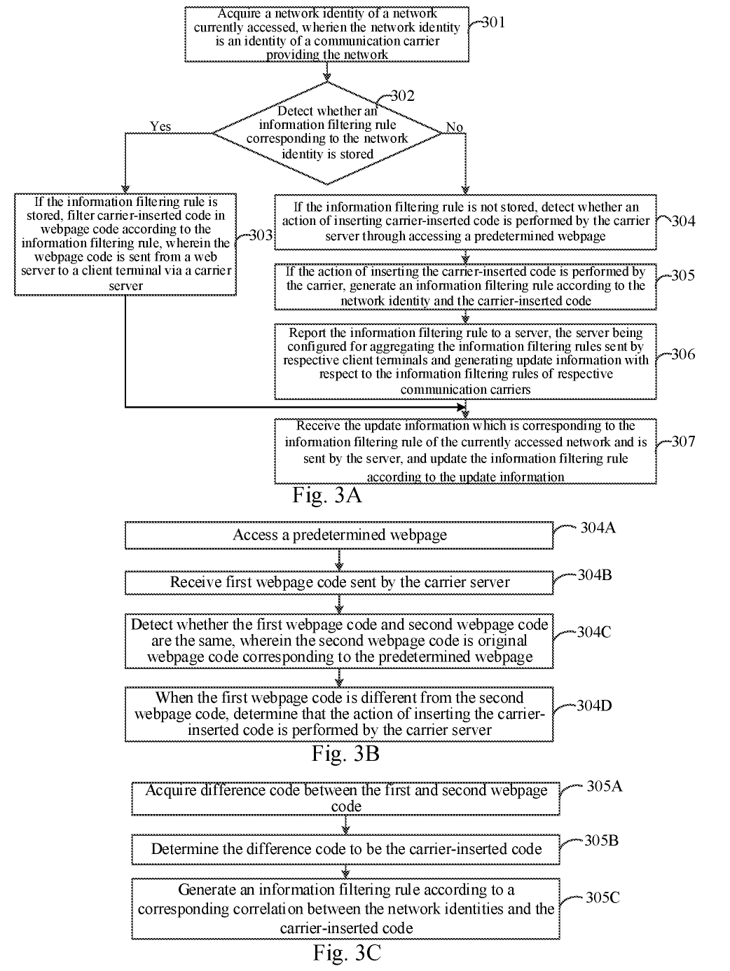

FIG. 3A is a flow chart showing a method for filtering information, according to another exemplary embodiment. In the present embodiment, the method for filtering information used in the electronic device 110 shown in FIG. 1 is explained. The method for filtering information may include the following steps.

In step 301, a network identity of a network currently accessed is acquired, the network identity being an identity of a communication carrier providing the network.

When the user accesses the network by using the electronic device installed with a browser client terminal, the client terminal may automatically acquire a network identity of the network, wherein the network identity is used for indicating the communication carrier providing the network. In normal conditions, the network identity is an ISP (Internet Service Provider) identity, and the client terminal may know the communication carrier corresponding to the currently connected network via the ISP identity.

As noted, the client terminal may acquire the network identity of the current network when a change of a connecting status of the network is detected, or may acquire the network identity of the current network every predetermined time interval. The present disclosure does not limit the timing at which the client terminal acquires the network identity.

In step 302, whether an information filtering rule corresponding to the network identity is stored is detected.

The information filtering rules for filtering code inserted by the carrier are pre-stored in the client terminal, wherein the information filtering rules are used for indicating a corresponding correlation between the network identities and the code inserted by the carriers, and the corresponding correlation may be as shown in the following Table 1.

TABLE 1

| Network Identities | Codes Inserted by Carriers |
|---|---|
| Communication carrier A | code A, code B, code C, code D |
| Communication carrier B | code E |
| Communication carrier C | Code F, code G |
| Communication carrier D | code H |

As noted, the code inserted by the carriers corresponding to different network identities may be or may not be the same, or may be partially the same. In the present embodiment, an example in which different network identities are corresponding to different code inserted by the carriers is explained, and the present disclosure is not limited thereto.

In normal conditions, different communication carriers insert different advertisements in the webpage, i.e., the information filtering rules with respect to different carriers are different, thus the client terminal needs to determine whether a corresponding information filtering rule is stored according to the acquired network identity. When detecting that the corresponding information filtering rule is stored, the advertisement inserted by the carrier may be filtered according to the information filtering rule, i.e., step 303 is performed; and when no corresponding information filtering rule is stored, step 304 is performed, as detailed below.

In step 303, if the information filtering rule is stored, code inserted by the carrier in webpage code is filtered according to the information filtering rule, wherein the webpage code is sent from a web server to a client terminal via a carrier server.

The steps 301-303 described above will be further illustrated with reference to FIG. 1. As shown in FIG. 1, the client terminal generates a corresponding HTTP request according to a website that needs to be accessed, and sends the HTTP request to a carrier server. Then the carrier server forwards the HTTP request to a corresponding web server. After receiving the HTTP request, the web server returns the corresponding webpage code to the client terminal via the carrier server, wherein the webpage code is generally HTML code. Once receiving the HTML code, the client terminal parses and displays the received HTML code to display the webpage. However, in normal conditions, the carrier server may insert an advertisement code in the HTML code. Thus, when receiving the HTML code, the client terminal may parse the advertisement code and display it on the webpage. Accordingly, the client terminal needs to filter the advertisement code inserted by the carrier server in the HTML code according to the stored information filtering rule.

For example, the client terminal acquires the network identity of the current network as “Communication carrier A” and a corresponding filtering rule is stored, then the client terminal detects whether code A and code B exist in the webpage code returned by the carrier server according to the information filtering rule. If the code A or code B exists, it is determined that there is an advertisement code inserted by the carrier, and the advertisement code is filtered. Since the advertisement code is filtered, the client terminal needs not to parse the advertisement code, and the advertisement inserted by the carrier will not appear on the webpage.

Referring back to FIG. 3A and continuing with step 303, in step 304, if the information filtering rule is not stored, detecting whether carrier-inserted code is inserted by the carrier server by accessing a predetermined webpage.

If the information filtering rule is not stored, the client terminal needs to further detect whether an action of inserting carrier-inserted code is performed by the carrier server. As one possible implementation manner, as shown in FIG. 3B, step 304 may include the following steps.

In step 304A, a predetermined webpage is accessed.

The client terminal pre-stores therein original webpage code corresponding to the predetermined webpage. When the client terminal accesses the predetermined webpage, whether the carrier inserts the carrier-inserted code may be judged by comparing the original webpage code and the received webpage code. In order to save the computing resource of the client terminal when comparing the webpage code, the client terminal generally accesses a blank page.

In step 304B, first webpage code sent by the carrier server is received.

The carrier server forwards the HTTP request sent by the client terminal to the corresponding web server, and the web server returns corresponding original webpage code according to the HTTP request. When the carrier server does not add the carrier-inserted code in the original webpage code, the first webpage code sent by the carrier server to the client terminal is same as the original webpage code; and when the carrier server adds the carrier-inserted code in the original webpage code, the first webpage code sent by the carrier server to the client terminal is formed by the original webpage code and the carrier-inserted code.

In step 304C, whether the first webpage code and second webpage code are the same is detected, wherein the second webpage code is original webpage code corresponding to the predetermined webpage.

The client terminal compares the received first webpage code and the original webpage code corresponding to the predetermined webpage. When the first webpage code is the same as the original webpage code, it is determined that the carrier server does not insert the carrier-inserted code; and when the first webpage code is different from the original webpage code, it is determined that the carrier-inserted code is inserted by the carrier server.

In step 304D, when the first webpage code is different from the second webpage code, it is determined that the action of inserting the carrier-inserted code is performed by the carrier server.

For example, when the predetermined webpage accessed by the client terminal is a blank page of the webpage, and the original webpage code corresponds to the blank page of the webpage, i.e., the second webpage code does not include therein any link node or script. When the received first webpage code includes therein link node or script, the client terminal may determine that the action of inserting the carrier-inserted code is performed by the carrier server.

Referring back to FIG. 3A and continuing with step 304, in step 305, when the action of inserting the carrier-inserted code is performed by the carrier server, an information filtering rule is generated according to the network identity and the carrier-inserted code.

When the client terminal determines that the action of inserting the carrier-inserted code is performed by the carrier server, the carrier-inserted code is filtered and a corresponding information filtering rule is generated. When the client terminal continues to access the webpage via the network, since the client terminal had already stored therein the generated information filtering rule, the carrier-inserted code may be filtered directly according to the information filtering rule. In accordance with some embodiments, as shown in FIG. 3C, step 305 may include the following steps.

In step 305A, difference code between the first and second webpage code is acquired.

For example, the predetermined webpage accessed by the client terminal is a blank page, when the first webpage code sent by the carrier server includes therein a link node or script, the client terminal may determine the link node or script as the difference code.

In step 305B, the difference code is determined to be the carrier-inserted code.

In step 305C, an information filtering rule is generated according to a corresponding correlation between the network identity and the carrier-inserted code.

The client terminal, according to the acquired network identity and the carrier-inserted code, generates an information filtering rule as shown in Table 1, and saves the generated information filtering rule. At this time, the client terminal stores the information filtering rule with respect to the current network.

Referring back FIG. 3A and continuing with step 305, in step 306, the information filtering rule generated by the client terminal is reported to a server, wherein this server is used for aggregating the information filtering rules sent by individual client terminals, and generating update information with respect to the information filtering rules of individual communication carriers.

Since the carrier server may insert different carrier-inserted code in different webpage code, the information filtering rule generated by the client terminal may filter the advertisements inserted by some of the carriers. Thus, the client terminal may report the stored information filtering rules to the server every predetermined time interval. The predetermined time interval may be the same, or may be different. For instance, the client terminal may report the information filtering rules every 24 hours, or may report the information filtering rules on the first day of each month. Accordingly, the filtering efficiency of the terminal is improved.

The server aggregates the information filtering rules reported by individual client terminals, and generates update information with respect to the information filtering rule of individual communication carrier.

For example, in the information filtering rules reported by the client terminal A, the carrier-inserted code corresponding to the communication carrier A are “code A” and “code B,” respectively. While in the information filtering rules reported by the client terminal B, the carrier-inserted code corresponding to the communication carrier A are respectively “code B,” “code C” and “code D,” respectively. Then the server may determine that the carrier-inserted code corresponding to the communication carrier A includes “code A,” “code B,” “code C” and “code D,” and generate the update information with respect to the information filtering rules of the communication carrier A, wherein the update information with respect to the client terminal A is “code C” and “code D,” and the update information with respect to the client terminal B is “code A.”

In step 307, the update information sent by the server is received and the information filtering rule is updated according to the update information, wherein the update information corresponds to the information filtering rule of the network.

The server sends the update information of the corresponding information filtering rule to individual client terminal, accordingly, individual client terminal updates the stored information filtering rule according to the update information, thus, a better filtering effect is achieved.

Thus, in the method for filtering information provided by the present exemplary embodiment, the code inserted by the carrier in the webpage code is filtered by using the information filtering rule corresponding to the current network, thus, the normal browsing of the user is not affected by the displaying of the advertisement inserted by the carrier on the webpage, and the advertisement inserted in the webpage by the carrier and ensuring the display of the webpage is filtered.

In the method for filtering information provided by the present exemplary embodiment, when no information filtering rule corresponding to the network identity is stored, whether the carrier-inserted code is inserted by the carrier server is detected by accessing a predetermined webpage; and when detecting that the carrier-inserted code is inserted by the carrier server, an information filtering rule is generated according to the carrier-inserted code and the network identity, and the carrier-inserted code is filtered. Thus, the client terminal flitters the advertisement inserted by the carrier server in real time, and saves the generated filtering rules, which improve the efficiency of filtering the advertisements.

Moreover, in the method for filtering information provided by the present exemplary embodiment, the server aggregates the information filtering rules sent by respective client terminals and generates update information with respect to the information filtering rules of respective communication carriers, thus, the information filtering rules stored in the client terminal may be supplemented and perfected, which further improves the efficiency of filtering the advertisements.

In accordance with some embodiments, devices for filtering informationare described hereinafter, which may be used for performing methods for filtering information. For the details not described in the embodiments of devices of the present disclosure, please refer to the embodiments of methods of the present disclosure.

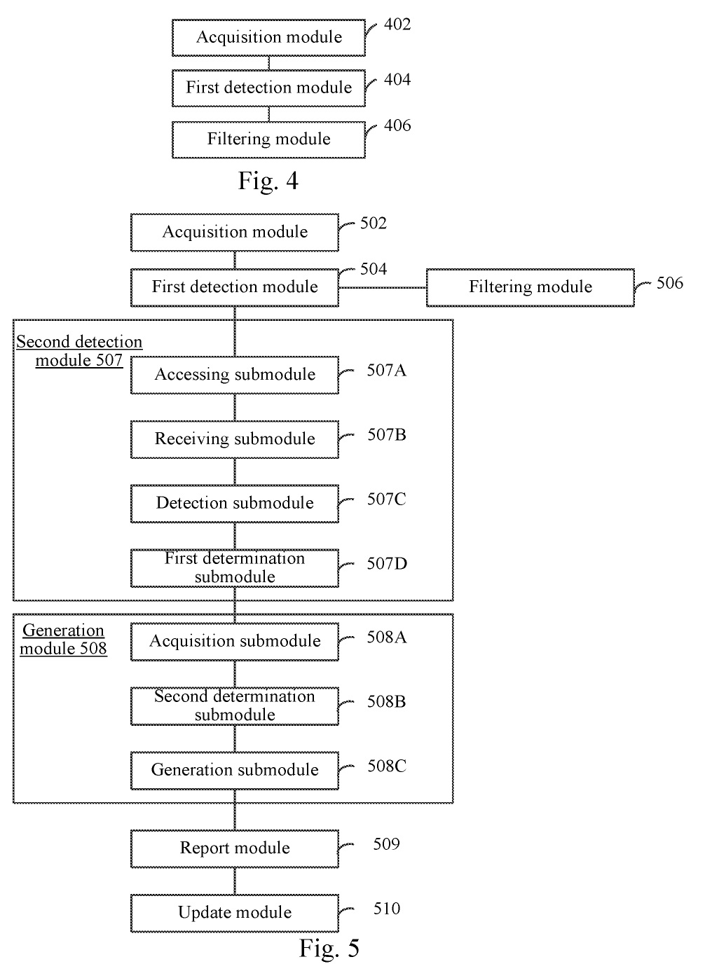

FIG. 4 illustrates a block diagram of an apparatus for filtering information, according to an exemplary embodiment. The apparatus for filtering information may be implemented to be a part or whole of the electronic device 110 shown in FIG. 1 by software, hardware or a combination of them. The apparatus for filtering information may include an acquisition module 402, a first detection module 404, and a filtering module 406.

The acquisition module 402 is configured to acquire a network identity of a network currently accessed, wherein the network identity is an identity of a communication carrier providing the network.

The first detection module 404 is configured to detect whether an information filtering rule corresponding to the network identity is stored.

The filtering module 406 is configured to, if the information filtering rule is stored, filter carrier-inserted code in webpage code according to the information filtering rule, wherein the webpage code is sent from a web server to a client terminal via a carrier server.

Thus, in the apparatus for filtering information provided by the present exemplary embodiment, the code inserted by the carrier in the webpage code is filtered by using the information filtering rule corresponding to the current network, thus, the normal browsing of the user is not affected by the displaying of advertisement inserted by the carrier on the webpage, and the advertisement inserted in the webpage by the carrier and ensuring the display of contents of the webpage is filtered.

FIG. 5 illustrates a block diagram of an apparatus for filtering information, according to another exemplary embodiment. The apparatus for filtering information may be implemented to be a part or whole of the electronic device 110 shown in FIG. 1 by software, hardware or a combination of them. The apparatus for filtering information may include an acquisition module 502, a first detection module 504, and a filtering module 506.

The acquisition module 502 is configured to acquire a network identity of a network currently accessed, wherein the network identity is an identity of a communication carrier providing the network.

The first detection module 504 is configured to detect whether an information filtering rule corresponding to the network identity is stored.

The filtering module 506 is configured to, if the information filtering rule is stored, filter carrier-inserted code in webpage code according to the information filtering rule, wherein the webpage code is sent from a web server to a client terminal via a carrier server.

Optionally, the apparatus further includes a second detection module 507 and a generation module 508.

The second detection module 507 is configured to, if the information filtering rule is not stored, detect whether an action of inserting the carrier-inserted code is performed by the carrier server through accessing a predetermined webpage.

The generation module 508 is configured to, if the action of inserting the carrier-inserted code is performed by the carrier server, generate an information filtering rule according to the network identity and the carrier-inserted code.

Optionally, the second detection module 507 includes an accessing submodule 507A, a receiving submodule 507B, a detection submodule 507C and a first determination submodule 507D.

The accessing submodule 507A is configured to access a predetermined webpage.

The receiving submodule 507B is configured to receive first webpage code sent by the carrier server.

The detection submodule 507C is configured to detect whether the first webpage code is the same as second webpage code, wherein the second webpage code is original webpage code corresponding to the predetermined webpage.

The first determination submodule 507D is configured to, if the first webpage code is different from the second webpage code, determine that the action of inserting the carrier-inserted code is performed by the carrier server.

Optionally, the generation module 508 includes an acquisition submodule 508A, a second determination submodule 508B and a generation submodule 508C.

The acquisition submodule 508A is configured to acquire difference code between the first and second webpage code.

The second determination submodule 508B is configured to determine the difference code as the carrier-inserted code.

The generation submodule 508C is configured to generate the information filtering rule according to a corresponding correlation between the network identity and the carrier-inserted code.

Optionally, the apparatus further includes a report module 509 and an update module 510.

The report module 509 is configured to report the information filtering rule to a server, wherein the server is configured for aggregating the information filtering rules sent by respective client terminals and generating update information with respect to the information filtering rules of respective communication carriers.

The update module 510 is configured to receive the update information sent by the server and update the information filtering rule according to the update information, wherein the update information corresponds to the information filtering rule of the network.

Thus, in the apparatus for filtering information provided by the present exemplary embodiment, the code inserted by the carrier in the webpage code is filtered by using the information filtering rule corresponding to the current network, thus, the normal browsing of the user is not affected by the displaying of advertisement inserted by the carrier on the webpage, and the advertisement inserted in the webpage by the carrier and ensuring the display of the webpage is filtered.

In the apparatus for filtering information provided by the present exemplary embodiment, when no information filtering rule corresponding to the network identity is stored, whether the carrier-inserted code is inserted by the carrier server is detected by accessing a predetermined webpage; and when detecting that the carrier-inserted code is inserted by the carrier server, an information filtering rule is generated according to the carrier-inserted code and the network identity, and the carrier-inserted code is filtered, thus, the client terminal filters the advertisements inserted by the carrier server in real time, and saves the generated filtering rules, which improve the efficiency of filtering the advertisements.

Moreover, in the apparatus for filtering information provided by the present exemplary embodiment, the server aggregates the information filtering rules sent by respective client terminals and generates update information with respect to the information filtering rules of respective communication carriers, thus, the information filtering rules stored in the client terminal may be supplemented and perfected, which further improves the efficiency of filtering the advertisements.

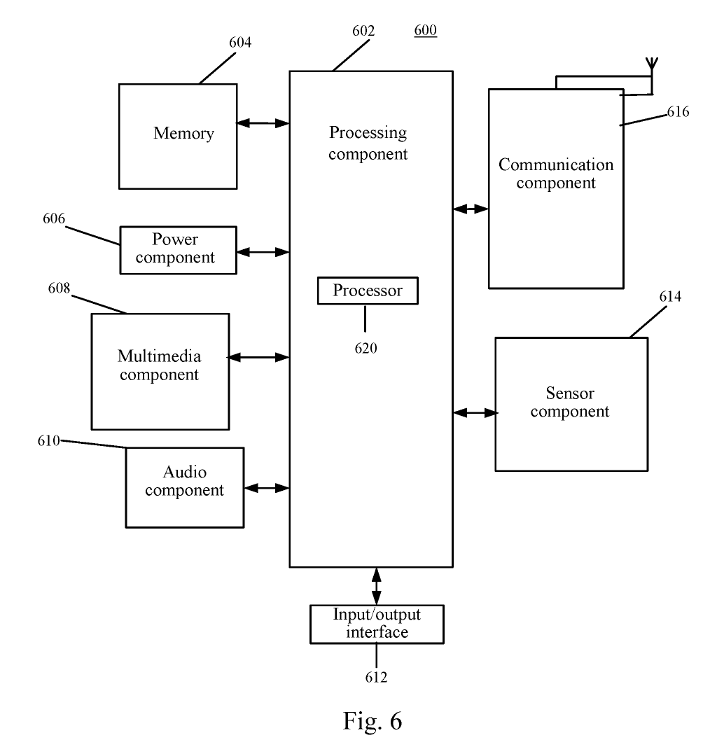

FIG. 6 is a block diagram of a device 600 for filtering information, according to an exemplary embodiment. For example, the device 600 may be the electronic device 110 shown in FIG. 1, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and/or the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G or 3G or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium is provided. When the instructions in the storage medium is performed by the processor of the device 600, the device 600 can perform the method for filtering information applied in the electronic device 110 shown in FIG. 1.

Other embodiments will be apparent to those skilled in the art from consideration of the specification disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for filtering information, comprising:
acquiring a network identity of a network currently accessed, wherein the network identity is an identity of a communication carrier providing the network;
detecting whether an information filtering rule corresponding to the network identity is stored; and
if the information filtering rule is stored, filtering carrier-inserted code in webpage code according to the information filtering rule, wherein the webpage code is sent from a web server to a client terminal via a carrier server.

2. The method according to claim 1, further comprising:
if the information filtering rule is not stored, detecting whether an action of inserting the carrier-inserted code is performed by the carrier server through accessing a predetermined webpage; and
if the action of inserting the carrier-inserted code is performed by the carrier server, generating an information filtering rule according to the network identity and the carrier-inserted code.

3. The method according to claim 2, wherein detecting whether the action of inserting the carrier-inserted code is performed by the carrier server through accessing the predetermined webpage comprises:
accessing the predetermined webpage;
receiving first webpage code sent by the carrier server;
detecting whether the first webpage code is the same as second webpage code, wherein the second webpage code is original webpage code corresponding to the predetermined webpage; and
if the first webpage code is different from the second webpage code, determining that the action of inserting the carrier-inserted code is performed by the carrier server.

4. The method according to claim 3, wherein generating the information filtering rule according to the network identity and the carrier-inserted code comprises:
acquiring difference code between the first and second webpage code;
determining the difference code as the carrier-inserted code; and
generating an information filtering rule according to a corresponding correlation between the network identity and the carrier-inserted code.

5. The method according to claim 1, further comprising:
reporting the information filtering rule to a server, wherein the server is configured for aggregating the information filtering rules sent by respective client terminals and generating update information with respect to the information filtering rules of respective communication carriers; and
receiving the update information sent by the server and updating the information filtering rule according to the update information, wherein the update information corresponds to the information filtering rule of the network.

6. The method according to claim 2, further comprising:
reporting the information filtering rule to a server, wherein the server is configured for aggregating the information filtering rules sent by respective client terminals and generating update information with respect to the information filtering rules of respective communication carriers; and
receiving the update information sent by the server and updating the information filtering rule according to the update information, wherein the update information corresponds to the information filtering rule of the network.

7. The method according to claim 3, further comprising:
reporting the information filtering rule to a server, wherein the server is configured for aggregating the information filtering rules sent by respective client terminals and generating update information with respect to the information filtering rules of respective communication carriers; and
receiving the update information sent by the server and updating the information filtering rule according to the update information, wherein the update information corresponds to the information filtering rule of the network.

8. The method according to claim 4, further comprising:
reporting the information filtering rule to a server, wherein the server is configured for aggregating the information filtering rules sent by respective client terminals and generating update information with respect to the information filtering rules of respective communication carriers; and
receiving the update information sent by the server and updating the information filtering rule according to the update information, wherein the update information corresponds to the information filtering rule of the network.

9. A device for filtering information, comprising:
a processor; and
a memory for storing instructions executable by the processor;
wherein the processor is configured to:
acquire a network identity of a network currently accessed, wherein the network identity is an identity of a communication carrier providing the network;
detect whether an information filtering rule corresponding to the network identity is stored; and
if the information filtering rule is stored, filter carrier-inserted code in webpage code according to the information filtering rule, wherein the webpage code is sent from a web server to a client terminal via a carrier server.

10. The device according to claim 9, wherein the processor is further configured to:
if the information filtering rule is not stored, detect whether an action of inserting the carrier-inserted code is performed by the carrier server through accessing a predetermined webpage; and
if the action of inserting the carrier-inserted code is performed by the carrier server, generate the information filtering rule according to the network identity and the carrier-inserted code.

11. The device according to claim 10, wherein the processor is further configured to:
access the predetermined webpage;
receive first webpage code sent by the carrier server;
detect whether the first webpage code is the same as second webpage code, wherein the second webpage code is original webpage code corresponding to the predetermined webpage; and
if the first webpage code is different from the second webpage code, determine that the action of inserting the carrier-inserted code is performed by the carrier server.

12. The device according to claim 11, wherein the processor is further configured to:
acquire difference code between the first and second webpage code;
determine the difference code as the carrier-inserted code; and
generate the information filtering rule according to a corresponding correlation between the network identity and the carrier-inserted code.

13. The device according to claim 9, wherein the processor is further configured to:
report the information filtering rule to a server, wherein the server is configured for aggregating the information filtering rules sent by respective client terminals and generating update information with respect to the information filtering rules of respective communication carriers; and
receive the update information sent by the server and update the information filtering rule according to the update information, wherein the update information corresponds to the information filtering rule of the network.

14. The device according to claim 10, wherein the processor is further configured to:
report the information filtering rule to a server, wherein the server is configured for aggregating the information filtering rules sent by respective client terminals and generating update information with respect to the information filtering rules of respective communication carriers; and
receive the update information sent by the server and update the information filtering rule according to the update information, wherein the update information corresponds to the information filtering rule of the network.

15. The device according to claim 11, wherein the processor is further configured to:
report the information filtering rule to a server, wherein the server is configured for aggregating the information filtering rules sent by respective client terminals and generating update information with respect to the information filtering rules of respective communication carriers; and
receive the update information sent by the server and update the information filtering rule according to the update information, wherein the update information corresponds to the information filtering rule of the network.

16. The device according to claim 12, wherein the processor is further configured to:
report the information filtering rule to a server, wherein the server is configured for aggregating the information filtering rules sent by respective client terminals and generating update information with respect to the information filtering rules of respective communication carriers; and
receive the update information sent by the server and update the information filtering rule according to the update information, wherein the update information corresponds to the information filtering rule of the network.

17. A non-transitory readable storage medium comprising instructions, executable by a processor in a device, for performing a method for filtering information, the method comprising:
acquiring a network identity of a network currently accessed, wherein the network identity is an identity of a communication carrier providing the network;
detecting whether an information filtering rule corresponding to the network identity is stored; and
if the information filtering rule is stored, filtering carrier-inserted code in webpage code according to the information filtering rule, wherein the webpage code is sent from a web server to a client terminal via a carrier server.
